(19) United States
(12) Patent Application Publication
(10) Pub. No.: US 2007/0061469 A1
(43) Pub. Date: Mar. 15, 2007

(54) Method of controlling data transmission and network apparatus for transmitting data using the same

(75) Inventors: Eun-hee Rhim, Suwon-si (KR); Kwang-yun Na, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/472,318

(22) Filed: Jun. 22, 2006

(30) Foreign Application Priority Data
Aug. 26, 2005 (KR) 10-2005-0078856

(51) Int. Cl. G06F 15/16

(52) U.S. Cl. 709/227

(57) ABSTRACT

A method of controlling data transmission, and a network apparatus for transmitting data using the same. The method includes performing data communication between network apparatuses via a first session, terminating the first session, establishing a second session while the first session is released by the termination, and performing data communication between the network apparatuses via the second session.

### CROSS-REFERENCE TO RELATED APPLICATION

This application claims priority from Korean Patent Application No. 10-2005-0078856 filed on Aug. 26, 2005 in the Korean Intellectual Property Office, the disclosure of which is incorporated herein in its entirety by reference.

### BACKGROUND OF THE INVENTION

1. Field of the Invention

Methods and apparatuses consistent with the present invention relate generally to control of data transmissions, and more particularly, to decreasing the latency time of data transmission when data is transmitted and received using the Internet Protocol (IP).

2. Description of the Related Art

Generally, a network architecture defines a communication protocol performed in the respective layers of different systems, an example of which is shown in FIG. 1.

FIG. 1 is a diagram illustrating the Open System Interconnection (OSI) reference model, which is a standard protocol that describes how a computer in a communication network transmits data.

The OSI reference model enables different communication devices to communicate with each other without conflict. In FIG. 1, seven layers are defined according to function.

Existing network devices and programs may be partially described with respect to their related layers within the hierarchical structure of the OSI reference model.

Referring to FIG. 1, an application layer is the highest layer to which user processes of a user. The application layer provides a means that allows an application program to access the connection functions of a system for the exchange of information. Communication services provided by the application layer hide the complexity of the lower layers of a communication program.

A presentation layer is involved in preserving the information content of data that is transmitted through a network. First, peer presentation layers of two communication systems must negotiate a common transmission context for the delivery of messages that are exchanged by two communication programs. Furthermore, the presentation layer allows a system to ignore how another system expresses data. The presentation layer also performs appropriate conversions so that a program performs tasks using its own data format without being concerned about the data format used by another party.

A session layer functions to establish a dialog between two communication programs and manage the data exchange between them. Dialogs can be classified into a full-duplex dialog, a half-duplex dialog, and a simplex dialog.

A transport layer implements high-quality, high-efficiency data transmission between processes of end computer systems. Therefore, when the service quality of a network layer lower than the transport layer is not sufficient, the transport layer also functions to compensate for the insufficient service quality, thereby allowing a user to not be concerned about a communication network.

A network layer is involved in assigning paths and relaying data that is transmitted from one system to another system via a network.

A data link layer takes charge of the data transmission between systems in a single link. A physical layer actually transmits the signals, such as electrical signals, optical signals or radio frequency (RF) signals between communication devices.

Transmission Control Protocol/Internet Protocol (TCP/IP) communication is one of the most widely known communication methods. As illustrated in FIG. 2, TCP/IP has a hierarchical protocol structure similar to FIG. 1.

Referring to FIG. 2, the application layer of TCP/IP corresponds to the application, presentation and session layers of the seven OSI layers shown in FIG. 1. Furthermore, the transport layer of TCP/IP corresponds to the transport layer of the seven OSI layers, and the Internet layer of TCP/IP corresponds to the network layer of the seven OSI layers. The lowest layer of TCP/IP, that is, the network interface layer, corresponds to the data link layer of the seven OSI layers. Physical equipment, which is used for the implementation of the data link, and which corresponds to the physical layer of the seven OSI layers, is out of the range of the TCP/IP architecture. As a result, any type of physical communication line can perform TCP/IP communication as long as the functions of the network interface layer are implemented for the line.

The TCP/IP communication can be performed according to a connection-oriented protocol or a connectionless protocol. The representative communication using the connection-oriented protocol is TCP communication.

The TCP communication is performed through processes of establishing a connection, delivering data and releasing the connection. FIG. 3 is a diagram illustrating the path of stream data transmitted using the TCP communication.

Referring to FIG. 3, a TCP session 330 is established between a video content server 310 for providing video content, and a client 320 for playing content provided by the video content server 310, and the content data stored in the video content server 310 is delivered through the established TCP session 330.

In this case, the client 320 may include a data buffer 322 for buffering content data provided by the video content server 310, and a decoder 324 for decoding the buffered content data.

When a user stops or pauses the playing of corresponding video content while receiving and playing the video stream data from the video content server 310 using the TCP communication, the TCP session 330 between the video content server 310 and the client 320 is released. At this time, the data buffer 322 of the client 320 becomes empty and the TCP session 330 is terminated by the “3-way handshake” of the TCP communication.

In this case, if the user wishes to play the video content again, the user can request the data corresponding to the point where play was stopped, or data of another point, from the video content server 310. In this case, a new TCP session is established between the video content server 310 and the client 320, and data corresponding to the portion requested by the user is buffered in the buffer 322, and is then delivered to the decoder 324 so that playing can be resumed.

That is, in such a TCP communication environment, when a user stops the playing of video content for a while and then resumes playing the video content, processes for the termination of an existing session and the establishment of a new session are performed.

However, since the time for the termination of a session is much longer than the frame rate of video data, the user experiences a pause. That is, there is a problem in that the client 320 must wait a predetermined time for data transmission to resume in order to resume viewing the video content.

### SUMMARY OF THE INVENTION

The present invention provides a method of controlling data transmission, which decreases latency time for data transmission between network apparatuses which transmit and receive data, and a network apparatus which transmits data using the same.

According to an aspect of the present invention, there is provided a method of transmitting data, including performing data communication between network apparatuses via a first session; terminating the first session; establishing a second session while the first session is released by the termination; and performing data communication between the network apparatuses via the second session.

According to another aspect of the present invention, there is provided a network apparatus, including a storage module for storing predetermined content; a session management module for establishing or releasing a session for transmitting data on the content; a control module for extracting the data from the storage module, delivering it to the session management module, and, when a first session via which data communication is currently being performed, is terminated, causing the session management module to establish a second session during release of the first session based on the termination, thereby performing data communication via the second session.

### BRIEF DESCRIPTION OF THE DRAWINGS

The above and other aspects of the present invention will be more clearly understood from the following detailed description of exemplary embodiments taken in conjunction with the accompanying drawings, in which:

FIG. 1 is a diagram of an OSI reference model;

FIG. 2 is a diagram illustrating an example of a TCP/IP protocol architecture;

FIG. 3 is a diagram illustrating an example path of a data stream transmitted using TCP communication;

FIG. 4 is a diagram illustrating an example of a communication system according to an exemplary embodiment of the present invention;

FIG. 5 is a block diagram illustrating the construction of a video content server according to an exemplary embodiment of the present invention; and

FIG. 6 is a flowchart illustrating a method of controlling data transmission according to an exemplary embodiment of the present invention.

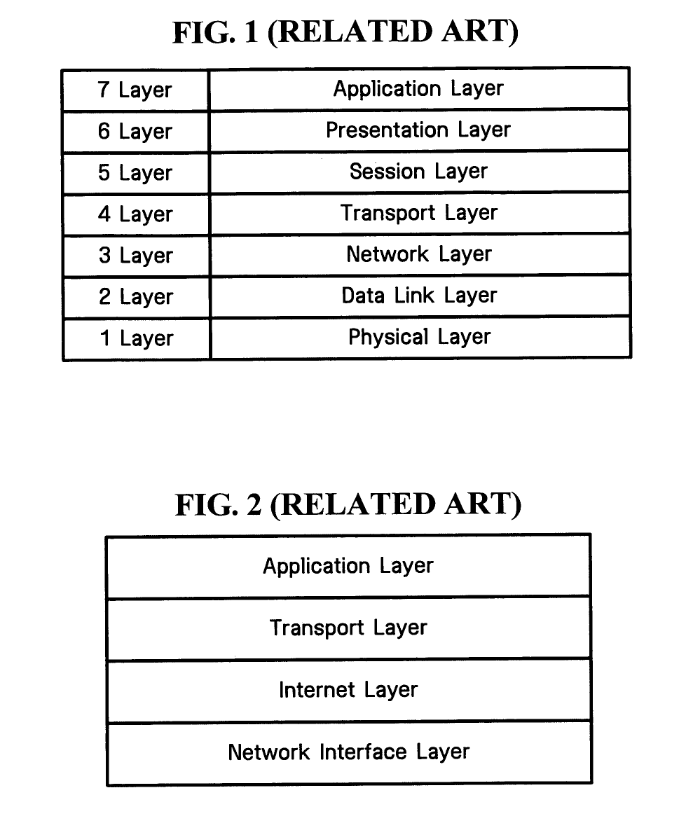

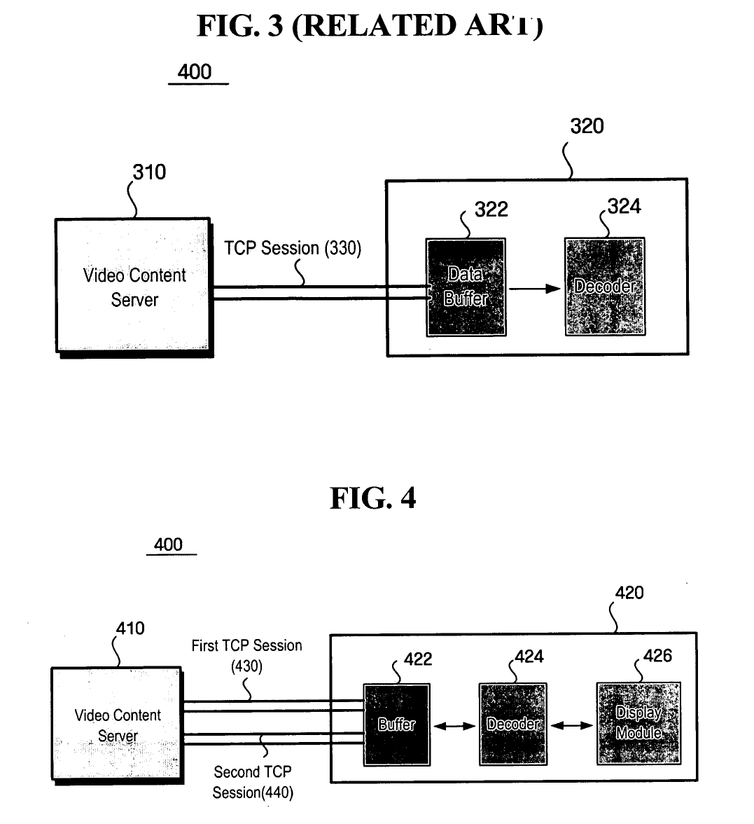

### DESCRIPTION OF THE EXEMPLARY EMBODIMENTS

Reference will be made to the drawings, in which the same reference numerals are used throughout the different drawings to designate the same or similar components.

The present invention is described hereinafter with reference to flowchart illustrations of user interfaces, methods, and computer program devices according to exemplary embodiments of the invention. It will be understood by those of ordinary skill in the art that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner such that the instructions stored in the computer usable or computer-readable memory produce an article of manufacture including instruction means that implement the functions specified in the flowchart block or blocks.

The computer program instructions may also be loaded into a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

Further, each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order depending upon the functionality involved.

Although the present invention is described with TCP communication taken as an example, it is not limited to this, but is applicable to a communication system which operates according to any connection-oriented protocol that is similar to TCP.

FIG. 4 is an example of a communication system 400 according to an exemplary embodiment of the present invention.

Referring to FIG. 4, the communication system 400 according to an exemplary embodiment of the present invention may include one network apparatus for requesting information and another network apparatus for providing information in response to the request. As an example, a client 420 for requesting video content and playing the video content, and a video content server 410 for providing the video content in response to the request are described.

Furthermore, a plurality of TCP sessions may be established between the video content server 410 and the client 420. In this case, for explanatory convenience, it is assumed that two TCP sessions are established. One of the two TCP sessions is called a first TCP session 430, and the TCP session is called a second TCP session 440.

The client 420 includes a buffer 422, a decoder 424 and a display module 426. The buffer 422 buffers video stream data, which is received via the first TCP session 430 or the second TCP session 440. In this case, the video stream data is received through a predetermined network interface module (not shown) within the client 420, and is then delivered to the buffer 422.

The decoder 424 decodes and plays the video stream data buffered in the buffer 422, and the display module 426 provides the video content played by the decoder 424 to a user through a display screen.

Furthermore, the decoder 424 may take charge of controlling the establishment of a connection with the video content server 410, the transmission of data, and the release of the connection.

The video content server 410 and the client 420 maintain the first TCP session 430 and the second TCP session 440 therebetween. In this case, data communication is performed in any one TCP session, rather than in both TCP sessions.

For example, when the data communication is performed in the first session 430, that is, the video content server 410 transmits the video stream data to the client 420 via the first TCP session 430, the second TCP session 440 is maintained in an idle state.

When, during data communication via the first TCP session 430, the playing of the video content is stopped by the client 420, and the video content server 410 subsequently receives from the client 420 a command requesting the resumption of playing of the video content or a command requesting the playing of video content corresponding to another portion, the first TCP session 430 is released and the second TCP session 440, which was in the idle state, is activated, so that the video content server 410 transmits the requested video stream data to the client 420 via the activated second TCP session 440. At this time, the released first TCP session 430 enters an idle state.

In another exemplary embodiment, when, during the communication of client 420 with the video content server 410 via the first TCP session 430, the playing of video content is stopped by the client 420, and the video content server 410 subsequently receives from the client 420 a command requesting the resumption of playing of the video content or a command requesting the playing of video content corresponding to another portion, a connection releasing process may be performed on the first TCP session 430 while a connection establishing process may be performed on the second TCP session 440.

In the exemplary embodiments, a user of the client 420 does not experience a pause, and can continuously view the video content since another session is immediately established in response to a request for the play stoppage, which is generated by the client 420.

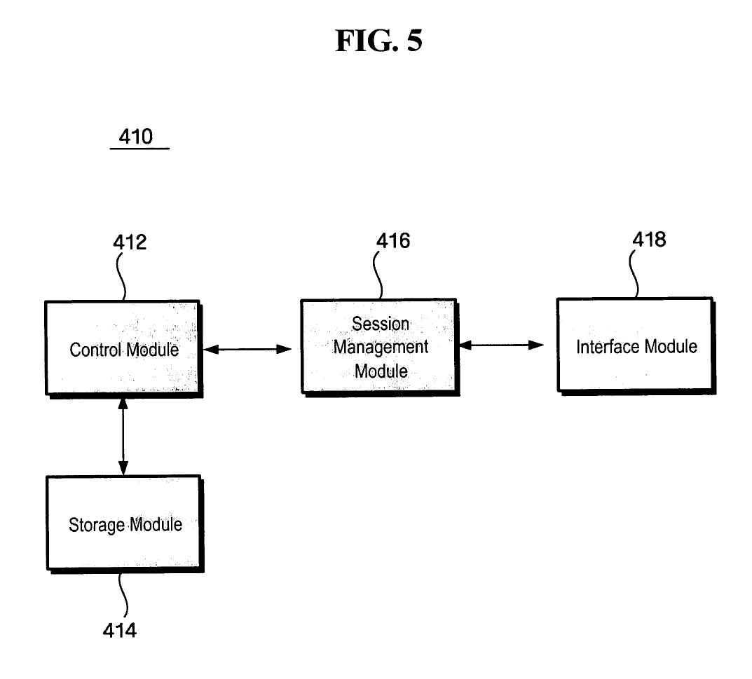

FIG. 5 is a block diagram illustrating the construction of a video content server according to an exemplary embodiment of the present invention.

Referring to FIG. 5, the video content server 410 includes a control module 412, a storage module 414, a session management module 416, and an interface module 418.

The term “module”, as used herein, means, but is not limited to, a software or hardware component, such as a Field Programmable Gate Array (FPGA) or an Application Specific Integrated Circuit (ASIC), which performs certain tasks. A module may advantageously be configured to reside in the addressable storage medium and configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules, or further separated into additional components and modules.

The storage module 414 stores various types of video content. The control module 412 controls the establishment of a connection, the transmission of data, and the release of the connection with respect to the client 420.

The session management module 416 manages sessions under the control of the control module 412. More particularly, when the control module 412 receives a command requesting play stoppage from the client 420, the control module 412 causes the session management module 416 to release the session, and to establish a new session. Furthermore, the session management module 416 transmits video stream data corresponding to the video content that the user wants to resume play of to the client 420 through the newly established session via the interface module 418.

Meanwhile, the TCP session established between the video content server 410 and the client 420 may be established by a socket.

In this case, the socket is generally a communication method between a client program and a server program in a network, and may be defined as “the end-point of a connection”. Furthermore, the socket is formed and implemented as a series of program requests or function calls, which is called a socket application programming interface (API). The sockets are also used for communication between the processes of the video content server 410 or of the client 420.

A single TCP session may be established by one socket, and a plurality of TCP sessions may be established by another socket.

The interface module 418 performs data communication with the client 420 through the TCP session established by the session management module 416.

The transmission medium that implements the TCP session may be a wired or wireless medium. The present invention can be applied to any transmission medium which can implement TCP communication.

Meanwhile, latency time for the reception of data may be lengthened depending on the state of the transmission medium in the client 420.

In this case, when a wait state continues for longer than a predetermined value, the client 420 and the video content server 410 release an existing TCP session and establish a new TCP session so that the flow of video stream data can be controlled.

That is, according to the exemplary embodiment of the preset invention, the release and establishment of the plurality of TCP sessions between the video content server 410 and the client 420 may be performed through play and stop commands from a user, or they may be performed depending on the wait state of a client.

In another exemplary embodiment, the client 420 includes a function for measuring the transmission speed and quality of data. If the measured transmission quality is lower than a predetermined quality threshold, the client 420 and the video content server 410 release an existing TCP session, and establish a new TCP session, thereby controlling the flow of video stream data.

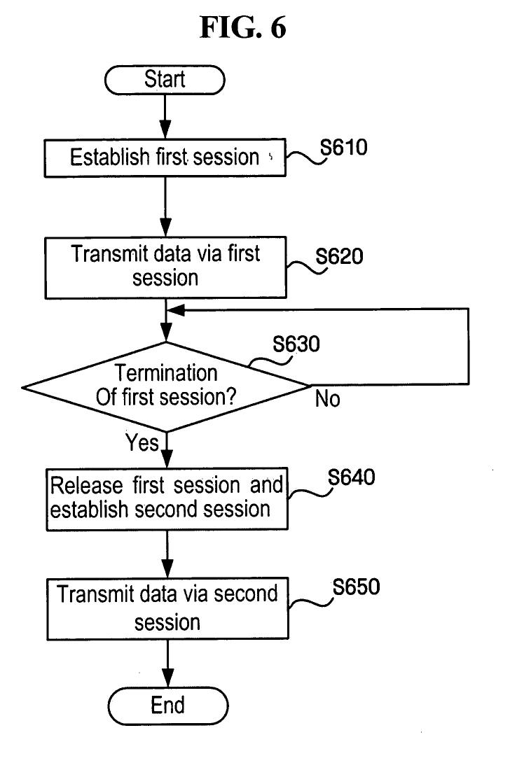

FIG. 6 is a flowchart illustrating a method of controlling data transmission according to an exemplary embodiment of the present invention.

First, a first TCP session is established between the video content server 410 and the client 420 at operation S610, and data transmission is performed between the video content server 410 and the client 420 via the first TCP session at operation S620.

Next, in operation 630, it is determined whether the first session is to be terminated, for example, because the video content server 410 receives a command requesting a play stoppage, or another TCP session is established. If it determined that the first session is to be terminated, the first TCP session is released, and the second TCP session is established in operation S640. Thereafter, data transmission is performed via the second TCP session between the video content server 410 and the client 420 in operation S650.

Meanwhile, a TCP session where data transmission is not being performed may be in an idle state.

According to the present invention, the latency time for data transmission may be decreased when data transmission is performed using a TCP connection.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of transmitting data, the method comprising the steps of:
performing data communication for transmitting predetermined content between first and second network apparatuses via a first session;
determining whether the first session is to be terminated;
establishing a second session while releasing the first session, if it is determined that the first session is to be terminated; and
performing data communication for transmitting the content between the first and second network apparatuses via the second session.

2. The method as set forth in claim 1, wherein the first and second sessions are Transmission Control Protocol sessions.

3. The method as set forth in claim 1, wherein during the performing of data communication between the first and second network apparatuses via the second session, the released first session is maintained in an idle state.

4. The method as set forth in claim 1, wherein the determining whether the first session is to be terminated comprises determining whether data transmission via the first session is stopped by the first or second network apparatus that requested the data.

5. The method as set forth in claim 1, wherein the determining whether the first session is to be terminated comprises determining whether a latency time for data transmission of the first or second network apparatus that requested the data is exceeded.

6. The method as set forth in claim 1, wherein the determining whether the first session is to be terminated comprises determining whether the first session is to be terminated based on data transmission speed and data quality.

7. The method as set forth in claim 1, wherein the data includes video stream data.

8. A network apparatus comprising:
a storage module which stores predetermined content;
a session management module which establishes and releases a session for transmitting content data;
a control module which extracts the data from the storage module, provides the extracted data to the session management module, and, if it is determined that a first session via which data communication is currently being performed, is to be terminated, causes the session management module to establish a second session while releasing the first session, and performs data communication for transmitting the content according at a user's request via the second session.

9. The network apparatus as set forth in claim 8, wherein the first and second sessions are Transmission Control Protocol sessions.

10. The network apparatus as set forth in claim 8, wherein the released first session is maintained in an idle state while performing the data communication via the second session.

11. The network apparatus as set forth in claim 8, wherein the first session is determined to be terminated if data transmission via the first session is stopped.

12. The network apparatus as set forth in claim 8, wherein the first session is determined to be terminated if a latency time of data transmission is exceeded.

13. The network apparatus as set forth in claim 8, wherein the control module determines whether the first session is to be terminated based on data transmission speed and data quality.

14. The network apparatus as set forth in claim 8, wherein the data includes video stream data.

15. A method of transmitting data, the method comprising:
establishing first and second communication sessions between first and second network apparatuses;
performing data communication between the first and second network apparatuses via the first communication session while maintaining the second connection in an idle state;
determining whether the first session is to be terminated;
activating the second communication session while releasing the first session, if it is determined that the first communication session is to be terminated; and
performing data communication between the first and second network apparatuses via the second communication session.

16. The method as set forth in claim 15, wherein the first and second communication sessions are Transmission Control Protocol sessions.

17. The method as set forth in claim 15, wherein during the performing of data communication between the first and second network apparatuses via the second communication session, the released first communication session is maintained in an idle state.

18. The method as set forth in claim 15, wherein the determining whether the first communication session is to be terminated comprises determining whether data transmission via the first communication session is stopped by the first or second network apparatus that requested the data.

19. The method as set forth in claim 15, wherein the determining whether the first communication session is to be terminated comprises determining whether a latency time for data transmission of the first or second network apparatus that requested the data is exceeded.

20. The method as set forth in claim 15, wherein the determining whether the first communication session is to be terminated comprises determining whether the first communication session is to be terminated based on data transmission speed and data quality.
